(19) United States
(12) Patent Application Publication
(10) Pub. No.: US 2026/0043690 A1
(43) Pub. Date: Feb. 12, 2026

(54) POLYIMIDE INSULATED THERMOCOUPLE BUNDLES

(71) Applicant: PRECISE DOWNHOLE SERVICES LTD., Nisku (CA)

(72) Inventor: Michael Melnychuk, Nisku (CA)

(21) Appl. No.: 19/296,518

(22) Filed: Aug. 11, 2025

Related U.S. Application Data
(60) Provisional application No. 63/681,679, filed on Aug. 9, 2024.

(51) Int. Cl. G01K 7/02; G01K 1/08; G01K 3/14

(52) U.S. Cl. CPC G01K 7/021; G01K 1/08; G01K 3/14

(57) ABSTRACT

A thermocouple cable is formed from a tubing and a plurality of polyimide insulated thermocouple conductors bundled within the tubing, wherein each thermocouple conductor forms a junction with a shared thermocouple conductor to form a thermocouple junction, and each thermocouple junction is attached to a support cable in a thermocouple bundle. The cable is formed by pulling the thermocouple bundle into the tubing.

### CROSS-REFERENCE TO RELATED APPLICATION

This application claims the priority benefit of United States Provisional Patent Application No. 63/681,679, filed on Aug. 9, 2025, the entire contents of which are incorporated herein by reference.

### FIELD OF THE INVENTION

The present invention relates to thermocouples and a thermocouple cable, particularly those configured to operate in high-temperature environments.

### BACKGROUND

Thermal recovery schemes are becoming increasingly common as conventional oil supplies decrease. Accordingly, unconventional schemes presenting downhole temperatures above 80° but typically below 350° C. are increasingly common. High quality temperature and pressure measurements to characterize the downhole environment are important in such schemes.

The ability of thermocouples to measure temperature is based on the observation that when two different electrically conductive materials are joined together at one end, and the temperature of the joined end is different than that of the open end, a millivoltage differential is produced. That differential can be measured and used to produce a temperature reading. Every conductor for the entire length of the thermocouple, between the joined end and the open end must be insulated.

Mineral insulated thermocouple conductors are widely used, but typically provide a limited number of discrete temperature sensing points. Also, mineral insulation is hygroscopic, and moisture accumulation can affect insulating capability over time.

While dielectric polymers are known and widely used in the oil and gas industry, they suffer from disadvantages which make them unsuited for thermal applications. Fluorothermoplastic polymers are known for their chemical resiliency, however will melt or soften and flow at the higher temperatures experienced in thermal oil recovery.

Long thermocouple cables having a large number of thermocouple junctions installed in tubing are capable of measuring temperature at multiple points along the cable. However, conventional methods of forming such long thermocouple cables result in a large number of failed connections, due at least in part to wire twisting, insulation damage and breakages.

Therefore, there is a need in the art for a thermocouple cable which may mitigate the disadvantages of the prior art, together with methods of making such cables.

### SUMMARY OF THE INVENTION

In one aspect, the invention comprises a thermocouple cable comprising a tubing and a plurality of thermocouple conductors bundled within the tubing, wherein each thermocouple conductor is a polyimide-insulated wire and forms a junction with a shared conductor wire to form a thermocouple junction, and each thermocouple junction is attached to a support cable. Preferably, the support cable runs at least the length between all thermocouple junctions and is attached to each thermocouple junction. In one embodiment, the shared conductor wire is also the support cable. Optionally, the tubing may be filled with a high-temperature matrix which embeds the bundle of thermocouple conductor.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows a schematic representation of a thermocouple cable assembled in accordance with one example of the present invention.

FIG. 2 shows a cross-sectional view of the cable of FIG. 1.

FIG. 3 is a schematic view of the formation of the first thermocouple (TC) point.

FIG. 4 is a schematic view of the wire spools used to form the first thermocouple junction.

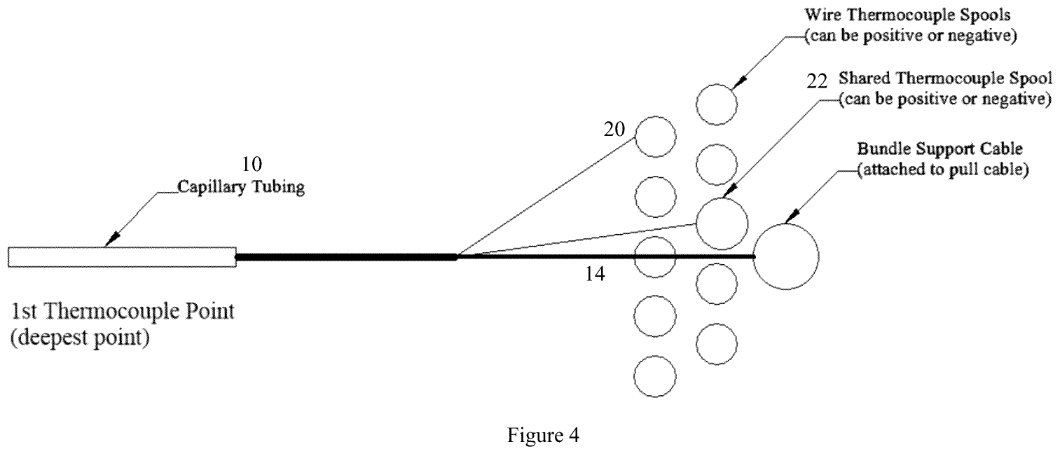

FIG. 5 is a schematic view of the formation of the second and subsequent thermocouple (TC) points.

FIG. 6 is a schematic view of the wire spools used to form the second thermocouple junction.

### DETAILED DESCRIPTION

As used herein, the “hot end” is the end of a thermocouple cable which is intended to be installed downhole, whereas the “cold end” is the end which remains at the surface and is connected to a data collection system which reads the thermocouple readings. The surface data collection system is not part of this invention. The hot and cold ends are identified to designate the orientation of the cable, and not to limit any temperature limitations at either end, or relative to one another.

As used herein, “high temperature materials” are those which do not experience significant degradation in their relevant properties at temperatures above about 200° C., more preferably 250° C., and most preferably 300° C. For example, high temperature materials may soften at elevated temperatures, but still maintain sufficient solidity to function as intended.

As used herein, “polyimide insulated wire” or “polyimide insulated conductor” is a metal wire coated with a layer of an insulating material comprising a polyimide. The coating layer comprise other polymers, such as PTFE or PFA, however it will comprise at least 50% (wt.) polyimide.

“Polyimide” is a class of polymers containing containing repeating imide groups, which are functional groups consisting of two acyl groups bound to nitrogen. The imide groups are formed by condensation reactions of an aromatic anhydride group with an aromatic amine.

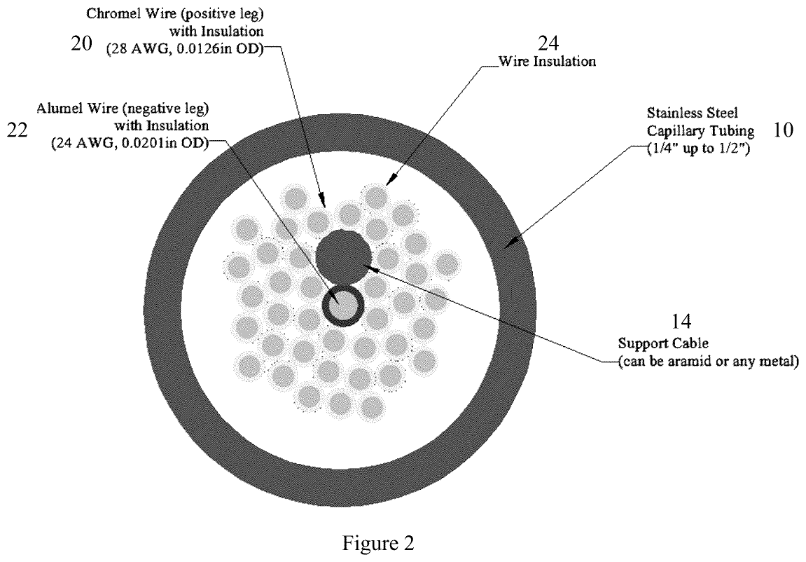

In one aspect of the invention, the invention comprises a thermocouple cable comprising a tubing (10) and a plurality of thermocouple conductors (20) bundled within the tubing, wherein each thermocouple conductor is a polyimide insulated wire and forms a junction (30) with a shared thermocouple conductor (22), and each thermocouple junction is attached to a backbone support cable (14). A cross-section of an assembled cable is shown in FIG. 2. As may be seen, a large number of thermocouple conductors can be housed in the tubing, such as a ½″ tubing. Optionally, the tubing may be filled with a matrix, preferably comprising a high-temperature material, which embeds the bundle of thermocouple conductors.

In a preferred embodiment, each thermocouple conductor comprises a polyimide enameled wire, such as an enameled copper wire may be between about 50 m to about 2000 m in length. A polyimide enameled wire is a wire which is dip-coated in a polyimide, providing a thin, uniform coating on the wire. The wire may comprise a standard 24 gauge (AWG) wire.

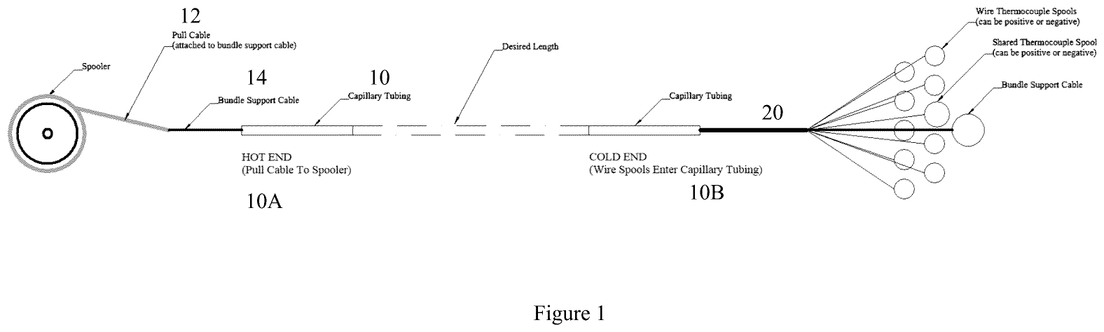

In one embodiment, the thermocouple cable may be formed by first providing the required or desired length of capillary tubing (10). A pull line (12), such as a stainless steel wire (or equivalent), is inserted into the tubing from the hot end (10A), such as by using an insertion pig (not shown). The pull line (12) does not form part of the final product, but is used to assemble the final product. When the pull line (12) emerges from the cold end (10B), it is connected to a support cable (14) which will eventually run substantially the entire length of the tubing (10). FIG. 1 shows the cable near completion of its assembly, after the support cable and the plurality of thermocouple junctions have been pulled through the tubing.

Preferably, the support cable (14) comprises a suitable high tensile and high temperature material, which may comprise high-strength steel wire or an aramid fiber cable, such as Kevlar™ or Technora™. It is preferred that the support cable (14) resist significant stretching, particularly at elevated temperatures, and have test strength of at least about 200 lbs, and preferably higher. However, if the thermocouple cable is not intended to be used in high-temperature applications (greater than about 200° C.), then high-temperature materials need not necessarily be used. In some embodiments, the support cable (14) is electrically conductive and is also the shared conductor wire (22).

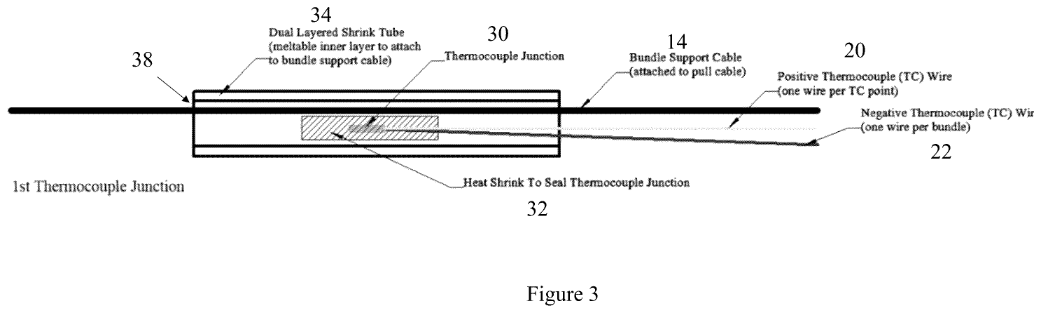

As shown in FIG. 3, a first thermocouple conductor (20) is connected to the shared conductor wire (22) to make the first thermocouple (TC) junction (30), using any conventional method, such as a twisting and solder junction connection as is well known in the art. A heat shrink cover (32) may be placed over the junction to seal it from moisture, which cover is preferably resistant to high-temperatures.

In preferred embodiments, each thermocouple conductor and the shared conductor wire are each electrically insulated for the length of the cable with a polyimide coating.

The first TC junction (30) is then secured to the support cable (14) in a suitable manner, such as by another heat shrink sleeve (34), which provides a secure physical connection between the TC junction (30) and the support cable (14). Preferably, the heat shrink sleeve (34) is a dual layer sleeve, which comprises a solid outer layer (36) and a meltable inner layer (38). Preferably, the heat shrink sleeve comprises fluoropolymers. In one embodiment, the dual layer sleeve comprises an outer layer (36) which comprises polytetrafluoroethylene or PTFE, which has a melting point of 327° C., while the inner layer (38) may comprise perfluoroalkoxy or PFA alkane copolymers of tetrafluoroethylene (TFE) and perfluoroethers. PFAs also have a high melting point (up to 315° C.) but, unlike PTFE, may be melt-processed. An alternative material for the inner layer may comprise fluorinated ethylene propylene (FEP) which is a copolymer of hexafluoropropylene and TFE, and which has a melting point of 260° C.

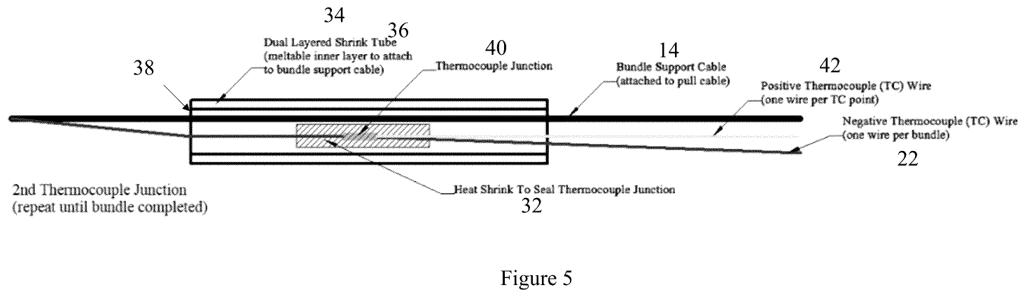

The first TC junction (30) and support cable (14) is then pulled into the tubing (10) until the second TC junction interval which may be, for example, about 1 meter to about 10 meters. As shown in FIG. 5, a second thermocouple conductor (42) is connected to the shared thermocouple conductor (22) to form a second TC junction (40), and secured to the support cable (14), preferably in like manner to the first TC junction (30).

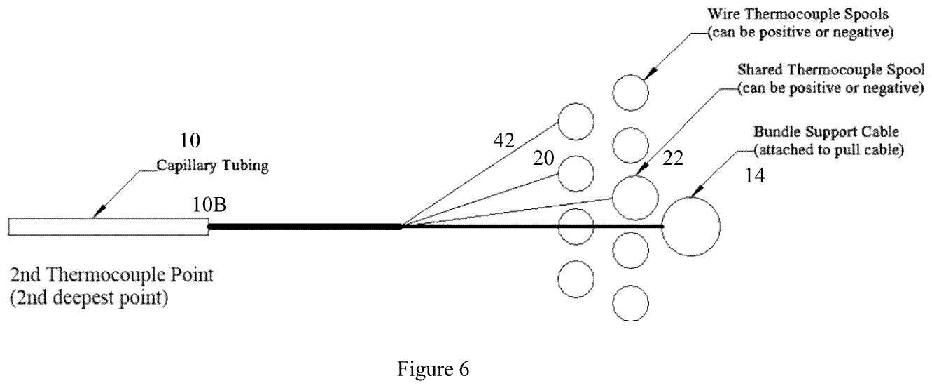

At this point, the bundle consists of the support cable, the shared thermocouple conductor, and the first and second thermocouple conductors, as shown in FIG. 6. The process is then repeated for as many TC junctions as are desired, which may be dozens or even hundreds. In one embodiment, each thermocouple conductor wire may be colour coded to ensure correct identification and depth verification.

Once all of the TC junctions are formed, the support cable (14) may be cut at the cold end and the thermocouple bundles may be pulled all the way such that the first TC junction (30) is at least adjacent the hot end. When assembled, the support cable (14) is buried in the tubing and physically supports at least a majority of the TC junctions, but is not required between the last TC junction and the cold end. As may be appreciated by one skilled in the art, not every TC junction need by secured to the support cable if sufficient connections are made to allow the support cable to fulfill its function.

The support cable (14) thus forms the backbone of the thermocouple string as it is securely connected to most if not all of the thermocouple conductors. As the TC junctions are pulled into the tubing one-by-one, it is not necessary to make a large number of points from the beginning. The thermocouple bundle is kept in constant tension as the support cable (14) is attached to each wire and prevents any wire from turning around on itself due to any twisting effects.

In an alternative embodiment, the shared conductor wire (22) may also serve as the support cable (14), as it may be strong enough to function to both as the shared conductor, and to provide the requisite physical support for the thermocouple string. In this embodiment, each thermocouple is formed as above and pulled into the tubing, but it is not necessary to then attach the thermocouple string to a separate support cable.

In some embodiments, it is preferred to displace oxygen from within the cable because polyimide may be susceptible to oxidative degradation. For example, the assembly process may take place in gaseous environment that does not include oxygen, such as a nitrogen environment. Alternatively, once assembled, the conductor cable may be purged with a gas free of oxygen, such as nitrogen. In another alternative, the tubing string may be filled with a sealant material which displaces substantially all gases in the tubing. High-temperature sealant materials such as silicone or epoxy may be used in such cases.

It may be desirable in some cases to physically and/or thermally protect the thermocouple conductors. For example, some examples of capillary tubing present a rough inner surface or an internal longitudinal seam which physically protrudes into the inner diameter of the tubing. In such cases, the thermocouple conductors may be abraded with pulled inside the tubing. Therefore, in some embodiments, the polyimide insulation layer on each conductor wire, or a bundle of conductor wires, may be physically and/or thermally protected by using a protective coating layer which may comprise silicone, a PTFE or PFA polymer, or the like.

In some embodiments, the thermocouple bundle may be wrapped in a protective tape, preferably a PTFE tape. The protective tape may be wound around the thermocouple bundle as it is being pulled into the tubing. Preferably, the tape is perforated so as to permit a purge gas or a sealant to penetrate the tape and displace any oxygen after assembly.

In some embodiments, each thermocouple conductor or the entire thermocouple bundle may be protected with at least one helical wire wrap, which is wound around the conductor or bundle with a sufficiently tight helical pitch that the conductor bundle does not contact the inner surface of the tubing as it is being pulled into and through the tubing. The helical wire wrap may comprise a single helix, or a plurality of helices. If more than one helical wrap is used, the helices may be overlapping (ie. opposing helical orientations) or non-overlapping (ie. aligned helical orientations). The helical wire wrap may comprise an insulated wire, although it is not necessary as the wire wrap does not itself conduct any electricity.

In one embodiment, as an alternative to pulling the thermocouple bundle into the tubing, the thermocouple bundle may be created outside the tubing (10) and then placed within a tubing blank before welding the blank into a tube.

### Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated. To the extent that the following description is of a specific embodiment or a particular use of the invention, it is intended to be illustrative only, and not limiting of the claimed invention.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all ranges described herein, and all language such as “up to”, “at least”, “greater than”, “less than”, “more than”, “or more”, and the like, include the number(s) recited and such terms refer to ranges that can be subsequently broken down into sub-ranges as discussed above.

What is claimed is:

1. A thermocouple cable comprises a tubing and a plurality of polyimide insulated thermocouple conductors bundled within the tubing, wherein each thermocouple conductor forms a junction with a shared thermocouple conductor to form a thermocouple junction, spaced apart from other thermocouple junctions, and each thermocouple junction is attached to a support cable in a thermocouple bundle.

2. The cable of claim 1 wherein the polyimide insulated thermocouple conductors comprise polyimide enameled wires.

3. The cable of claim 1, wherein the polyimide insulated thermocouple conductors comprise a physical or thermal protective coating.

4. The cable of claim 1 wherein the tubing is purged with an oxygen free gas and sealed at both ends.

5. The cable of claim 1, wherein the tubing is filled with a matrix which embeds the entire bundle of thermocouple conductors, points and bundles.

6. The cable of claim 5, wherein the matrix comprises a high-temperature material such as silicone.
